(19) United States
(12) Patent Application Publication
(10) Pub. No.: US 2018/0183651 A1
(43) Pub. Date: Jun. 28, 2018

(54) CONTENT PUSH METHOD AND SERVER, AND TERMINAL

(71) Applicant: BEIJING KINGSOFT INTERNET SECURITY SOFTWARE CO., LTD., BEIJING (CN)

(72) Inventor: Haiwang LIU, BEIJING (CN)

(21) Appl. No.: 15/903,516

(22) Filed: Feb. 23, 2018

Related U.S. Application Data
(63) Continuation of application No. PCT/CN2016/095894, filed on Aug. 18, 2016.

(30) Foreign Application Priority Data
Aug. 25, 2015 (CN) 201510526432.0

(51) Int. Cl. H04L 29/08; H04W 52/02

(52) U.S. Cl. CPC H04L 29/08693; H04L 67/26; H04L 12/1859; H04W 52/0261; H04W 52/0212

(57) ABSTRACT

Disclosed are a content push method, a server, and a terminal. The method comprises: acquiring historical running information about a terminal; determining a push scenario and a content to be pushed under the push scenario according to the historical running information, wherein the push scenario is a terminal running scenario, determined according to a pre-set modelling algorithm, where a decision factor which reflects user's demands in the historical running information is located; and detecting whether the terminal is in the push scenario, and if the terminal is in the push scenario, sending the content to be pushed to the terminal.

### CROSS REFERENCE TO RELATED APPLICATION

This application is a continuation of International Application No. PCT/CN2016/095894, filed on Aug. 18, 2016, which claims a priority to and benefits of Chinese Patent Application Serial No. 201510526432.0, filed with the State Intellectual Property Office of P. R. China on Aug. 25, 2015, the entire content of which is incorporated herein by reference.

### FIELD

The present disclosure relates to the field of internet technology, and more particularly to a content push method, a server and a terminal.

### BACKGROUND

Currently, with the development of internet technology, a variety of applications can be installed in a terminal, such as a smartphone, a tablet PC and other portable devices, for improving people's life, work and entertainment. In order to improve user's operating experience when using such applications, a specific interface run on the application is normally set with a fixed push content, which will be output once such a specific interface is running on the terminal.

However, it has been found in practice that the way that the specific interface is simply set with the fixed push content leads to the same push content output whenever the specific interface is running on the terminal, thus easily resulting in poor match between the push content and a user's operating requirement.

### SUMMARY

Embodiments of the present disclosure provide a content push method, a server and a terminal.

In embodiments of the present disclosure, a content push method applied in a server is provided. The method includes:

acquiring historical running information of a terminal;

determining a push scenario and a content to be pushed in the push scenario according to the historical running information, wherein the push scenario is a terminal running scenario providing a decision factor in the historical running information determined by a predetermined modeling algorithm and the decision factor reflects a user requirement;

detecting whether the terminal is in the push scenario; and

sending to the terminal the content to be pushed in the push scenario if the terminal is in the push scenario.

In embodiments of the present disclosure, a content push method applied in a terminal is provided. The method includes:

acquiring historical running information of the terminal; and

sending the historical running information of the terminal to a server such that the server determines whether the terminal is in a push scenario, wherein the server returns a content to be pushed in the push scenario if the terminal is in the push scenario, the historical running information includes at least one of historical operating information and historical device status information running on the terminal, and the push scenario is a terminal running scenario providing a decision factor in the historical running information determined by a predetermined modeling algorithm and the decision factor reflects a user requirement; and

receiving and outputting the content to be pushed in the push scenario which is returned by the server.

In embodiments of the present disclosure, a server is provided. The server includes a content push apparatus. The content push apparatus includes: one or more processors; a memory; one or more software modules stored in the memory and executable by the one or more processors, and includes:

an acquiring module configured to acquire historical running information in a terminal;

a determining module configured to determine a push scenario and a content to be pushed in the push scenario according to the historical running information acquired by the acquiring module, wherein the push scenario is a terminal running scenario providing a decision factor in the historical running information determined by a predetermined modeling algorithm and the decision factor reflects a user requirement;

a detecting module configured to detect whether the terminal is in the push scenario; and

a sending module configured to send to the terminal the content to be pushed in the push scenario determined by the determining module if the detecting module detects that the terminal is in the push scenario.

In embodiments of the present disclosure, a terminal is provided. The terminal includes a content push apparatus. The content push apparatus includes one or more processors; a memory; one or more software modules stored in the memory and executable by the one or more processors, and includes:

an acquiring module configured to acquire historical running information of the terminal;

a communicating module configured to send the historical running information of the terminal to a server such that the server determines whether the terminal is in a push scenario, wherein the server returns a content to be pushed in the push scenario if the terminal is in the push scenario, the historical running information comprises at least one of historical operating information and historical device status information running on the terminal, the push scenario is a terminal running scenario providing a decision factor in the historical running information determined by a predetermined modeling algorithm and the decision factor reflects a user requirement, and the communicating module is further configured to receive the content to be pushed in the push scenario which is returned by the server; and

an output module configured to output the content to be pushed which is received in the push scenario by the communicating module.

### BRIEF DESCRIPTION OF THE DRAWINGS

In order to more clearly illustrate the technical solutions in embodiments of the present disclosure, the drawings intended to be used in the embodiments are briefly described below. It will be apparent that the drawings in the following description are merely exemplary embodiments of the present invention. Those skilled in the art will be able to obtain additional drawings in accordance with these drawings without any inventive work.

FIG. 1 is a flow chart of a content push method according to an embodiment of the present disclosure;

FIG. 2 is a flow chart of another content push method according to an embodiment of the present disclosure;

FIG. 3 is a schematic diagram showing output configuration information according to an embodiment of the present disclosure;

FIG. 4 is a flow chart of a further content push method according to an embodiment of the present disclosure;

FIG. 5 is a flow chart of a further content push method according to an embodiment of the present disclosure;

FIG. 6 is a schematic diagram of a content push system according to an embodiment of the present disclosure;

FIG. 7 is a schematic diagram of a content push apparatus according to an embodiment of the present disclosure;

FIG. 8 is a schematic diagram of another content push apparatus according to an embodiment of the present disclosure;

FIG. 9 is a schematic diagram of a further content push apparatus according to an embodiment of the present disclosure;

FIG. 10 is a schematic diagram of a server according to an embodiment of the present disclosure; and

FIG. 11 is a schematic diagram of a terminal according to an embodiment of the present disclosure.

### DETAILED DESCRIPTION

Embodiments of the present disclosure will be described in details in the following descriptions, and it will be apparent that the described embodiments are only part of the embodiments of the present disclosure. All other embodiments which can be obtained by those skilled in the art without making any inventive work based on embodiments described in the present disclosure are within the scope of the present disclosure.

In the following, a content push method, a content push apparatus and a terminal are provided according to embodiments of the present disclosure, which improve the match between the push content and the user's operating requirement.

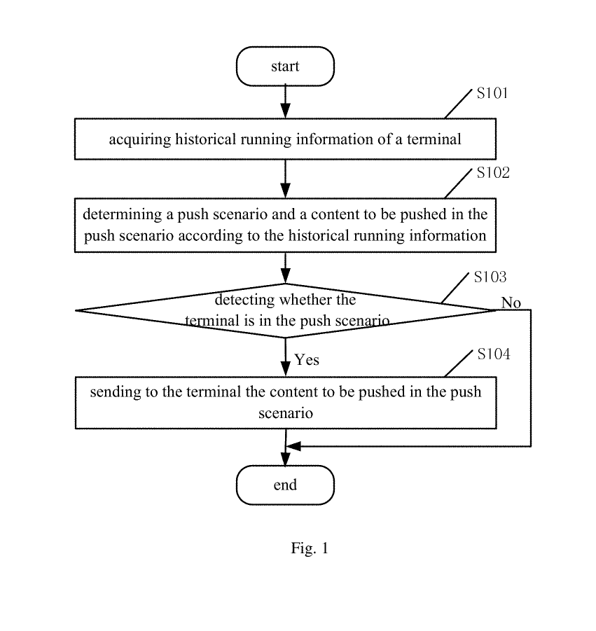

FIG. 1 is a flow chart of a content push method according to an embodiment of the present disclosure. As shown in FIG. 1, the content push method may include following steps.

S101, historical running information of a terminal is acquired.

In an embodiment of the present disclosure, steps included in the content push method may be performed by a background server or a third party server. Specifically, a terminal may be a mobile phone, a tablet computer, a laptop and other wearable device, etc., which is not limited to the embodiments of the present disclosure.

In an embodiment of the present disclosure, the historical running information may include at least one of historical operating information and historical device status information running on the terminal. Specifically, the historical operating information may include an application frequently used by a user in a predetermined time period, an application uninstalled by the user and other information such as an operating habit of the user in the terminal. The historical device status information may include a power consumption speed and an available memory size of a terminal, the number of applications installed in a terminal and other terminal status information.

S102, a push scenario and a content to be pushed in the push scenario are determined according to the historical running information.

In an embodiment of the present disclosure, the push scenario is a terminal running scenario providing a decision factor in the historical running information determined by a predetermined modeling algorithm and the decision factor reflects a user requirement. Specifically, the predetermined modeling algorithm may include a sorting algorithm, a data analysis algorithm and a data fitting algorithm; and the decision factor may be at least one of instructions or device statuses of the historical running information. If the decision factor is input as the predetermined modeling algorithm, a push scenario expected in the terminal may be determined, as well as a content expected by a user in such a push scenario, i.e., the content to be pushed in the push scenario.

S103, whether the terminal is in the push scenario is detected. If the terminal is in the push scenario, S104 is performed, and if the terminal is not in the push scenario, this procedure is ended.

S104, the content to be pushed in the push scenario is sent to the terminal.

In embodiments of the present disclosure, the content to be pushed in the push scenario may include installation package download links for various applications and their respective brief introductions, an entry prompting other operations and a predetermined content related to the historical running information for the individual application, etc., which is not limited to the embodiments of the present disclosure.

In an embodiment of the present disclosure, if the historical running information is historical operating information running on the terminal, the step of determining a push scenario and a content to be pushed in the push scenario according to the historical running information may be specifically performed as follows.

An operating instruction for triggering a push content and a content to be pushed corresponding to the operating instruction is determined according to the historical operating information.

Accordingly, in S103, detecting whether the terminal is in the push scenario includes: detecting whether the operating instruction is received by the terminal, and determining that the terminal is in the push scenario if the operating instruction is received by the terminal, such that the content to be pushed corresponding to the operating instruction may be send to the terminal.

For example, if the historical operating information is an application A most frequently used by a user in a predetermined time period, based on such historical operating information, it may be determined that the content to be pushed corresponding to the operating instruction is an application A1 which is the latest version of the application A or an application B which is newly published and in the same type as that of the application A when the operating instruction is to uninstall the application A. In S103, it may be detected whether such an operating instruction of uninstalling the application A is received by the terminal. If this operating instruction of uninstalling the application A is received, a download link or a brief introduction of the application A1 or B may be sent to the terminal.

In an embodiment of the present disclosure, if the historical running information is historical device status information running on the terminal, the step of determining a push scenario and a content to be pushed in the push scenario according to the historical running information may be specifically performed as follows.

A device status for triggering a push content and a content to be pushed corresponding to the device status are determined according to the historical device status information.

Accordingly, in S103, detecting whether the terminal is in the push scenario includes: detecting whether the terminal is in the device status, and determining that the terminal is in the push scenario if the terminal is in the device status, such that the content to be pushed corresponding to the device status may be sent to the terminal.

In an embodiment of the present disclosure, the historical device status information may include a power consuming speed and an available memory size of a terminal, and the number of applications running on a terminal. Accordingly, the device status in a push scenario determined according to the historical device status information may include a device status of a power consumption speed reaching a predetermined threshold in a predetermined time period, a device status of a terminal currently-available memory size reaching a predetermined threshold and a device status of the number of applications running on the terminal reaching a predetermined threshold. Accordingly, these device statuses may correspond to a power consumption managing application, a memory size managing application, and an application controlling those applications running on the terminal but not receiving an operating instruction in the predetermined time period to be in a hibernation state.

For example, if the server determines that the power consumption speed of the terminal is fast according to the historical running information of the terminal, the device status corresponding thereto may be the power consumption speed of the terminal reaching the predetermined threshold in the predetermined time period. Then in S103, it is detected whether the terminal is in such a device status, if yes, the content to be pushed according to the device status may be sent to the terminal, including at least one of a download link and a brief introduction for the power consumption managing application, and a directly-output prompt of “open the power consumption managing application” in case that the power consumption managing application has already been installed in the terminal. If the content to be pushed according to the device status is the prompt of “open the power consumption managing application”, the terminal may open the power consumption managing application immediately once receiving a confirmation instruction for the prompt.

In an embodiment of the present disclosure, if it is detected in S103 that the terminal is not in a determined push scenario, the current procedure may be the ended or the device status of the terminal may be detected again. Specifically, there may be a plurality of push scenarios determined according to the historical running information, that is, a correspondence table between a push scenario and a content to be pushed according to the device status may be pre-stored in a server, the terminal is then detected. If the terminal is detected to be in at least one of the push scenarios in the correspondence table, the server may send the content to be pushed according to the device status and corresponding to the at least one of the push scenarios to the terminal.

According to the content push method illustrated in FIG. 1, the historical running information of a terminal is acquired, a push scenario and a content to be pushed in the push scenario are determined according to the historical running information (in which the push scenario is a terminal running scenario providing a decision factor in the historical running information determined by a predetermined modeling algorithm and the decision factor reflects a user requirement), the content to be pushed corresponding to the push scenarios determined above is sent to the terminal when the terminal is detected to be in such the push scenario, such that the terminal outputs the content to be pushed corresponding to the push scenarios determined. Therefore, according to embodiments of the present disclosure, it is possible to push different contents according to different running scenarios of the terminal, thus improving the match between the push content and the user's operating requirements.

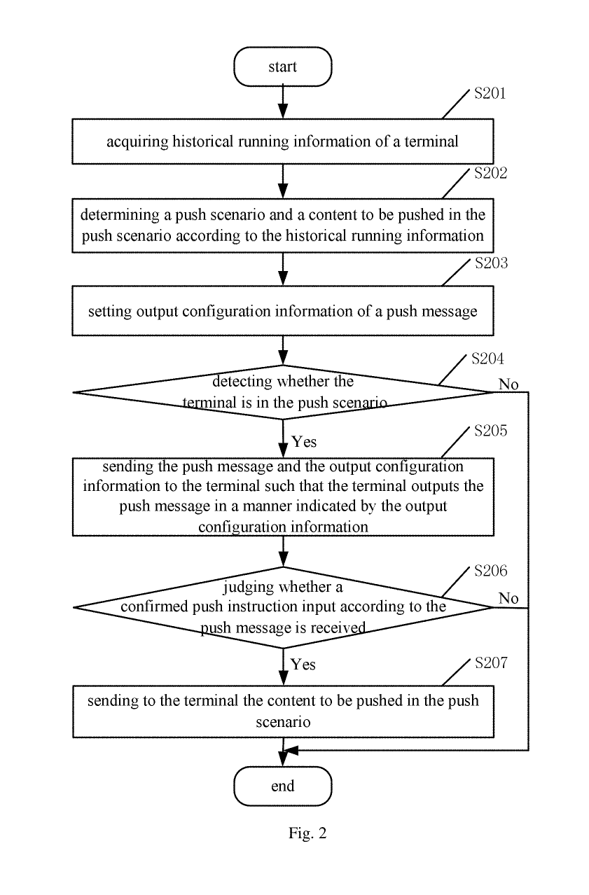

FIG. 2 is a flow chart of another content push method according to an embodiment of the present disclosure. As shown in FIG. 2, the content push method includes following steps.

S201, historical running information of the terminal is acquired.

S202, a push scenario and a content to be pushed in the push scenario are determined according to the historical running information, wherein the push scenario is a terminal running scenario providing a decision factor in the historical running information determined by a predetermined modeling algorithm and the decision factor reflects a user requirement.

In an embodiment of the present disclosure, descriptions of S201 and S202 may refer to the detailed descriptions of S102 and S102, which are not elaborated herein.

S203, output configuration information of a push message is set.

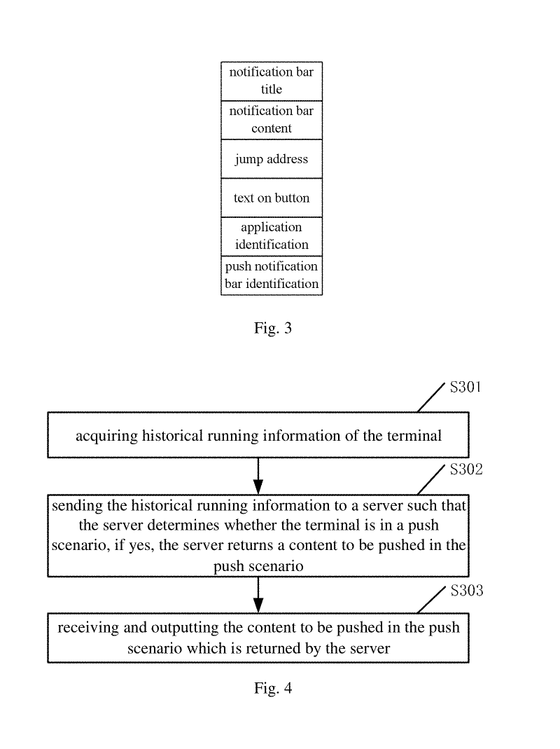

In an embodiment of the present disclosure, the push message is configured to indicate the content to be pushed which is pushed in the terminal running scenario and may include a download link and a brief introduction for an application to be pushed, and an entry prompting other operations (e.g., updating an application), etc.. The output configuration information includes at least one of an output manner and an output location of the push message, and a jump address of the content to be pushed in the push scenario. For example, the output configuration information may be predefined in a server, or set by a user via a configuration interface as shown in FIG. 3. FIG. 3 is a schematic diagram showing output configuration information according to an embodiment of the present disclosure. A content to be set of the output configuration information may include a notification bar title, a notification bar content, a jump address, a text on button, an application identification, and a push notification bar identification. Taking the push message is configure to indicate that the content to be pushed corresponding to the operating instruction is the power consumption managing application A1 as an example, in the output configuration information, the notification bar title may be set as the power consumption managing application, the notification bar content may be set as a brief introduction for the power consumption managing application A1 (such as a memory size occupied for installation, a developer and version information), the jump address may be set as a download link for the power consumption managing application A1, the text on button may be set to confirm or to ignore the push message, an application identification may be set as an icon of the power consumption managing application A1 and the push notification bar identification may be set as an icon of the push content corresponding to the device status.

S204, whether the terminal is in the push scenario is detected. If the terminal is in the push scenario, S205 is performed otherwise the procedure is ended.

S205, the push message and the output configuration information are sent to the terminal such that the terminal outputs the push message in a manner indicated by the output configuration information.

In an embodiment of the present disclosure, if the terminal is detected to be in the push scenario, the push message and the output configuration information are sent to the terminal, such that the push message is output in the manner indicated by the output configuration information by the terminal. Alternatively, the output configuration information may also be in a voice prompt manner, for example, except for the jump address which may be output in a prompt bar manner, other information of the output configuration information described above, such as the notification bar title, the notification bar content, the text on button, the application identification and the push notification bar identification, may be output in the voice prompt manner. Alternatively, the output configuration information may be set as broadcasting the push message including the brief introduction for the content to be pushed in the voice prompt manner only.

S206, whether a confirmed push instruction input according to the push message is received is judged. If the confirmed push instruction input according to the push message is received, S207 is performed; otherwise, the procedure is ended.

In an embodiment of the present disclosure, the confirmed push instruction may be a click instruction or a sliding operation by the user for confirming the text on button input in the prompt bar for the push message output as the output configuration information, or an voice confirmation instruction input by the user in response to the push message, as well as other preset operating instructions for confirming the allowed content to be pushed, which is not limited to embodiments of the present disclosure.

S207, the content to be pushed in the push scenario is sent to the terminal.

In embodiments of the present disclosure, descriptions of 5205 to 5207 may refer to relevant description for S102 to S104, which are not elaborated in detail herein.

In an embodiment of the present disclosure, the content to be pushed is different from the push message. For example, when the confirmed push instruction input according to the push message is received, a download website of an application to be pushed may be showed up directly, or an application corresponding to the push scenario may be opened directly. Therefore, the push message is a prompt or an inquiry configured to confirm whether the user allows to push the content to be pushed before the content to be pushed is actually pushed.

According to the content push method illustrated in FIG. 2, the historical running information of a terminal is acquired, and a push scenario and a content to be pushed in the push scenario are determined according to the historical running information. Moreover, output configuration information for the push message may also be set, the push message and the output configuration information may be sent to the terminal such that the terminal may output the push message in a manner indicated by the output configuration information when the terminal is detected to be in the push scenario. Once the confirmed push instruction input according to the push message is received, the content to be pushed in the push scenario is sent to the terminal. Therefore, according to embodiments of the present disclosure, it is possible to determine the content to be pushed in better match with the terminal currently-running scenario according to the historical running information of the terminal, and to send the content to be pushed in the push scenario to the terminal only after the confirmed push instruction input according to the push message is received, thus improving the match between the push content and the user's operating requirement.

FIG. 4 is a flow chart of a further content push method according to an embodiment of the present disclosure. As shown in FIG. 4, an executive body for the content push method is a terminal. The terminal may be any one of a mobile phone, a tablet computer, a laptop and other wearable device. As shown in FIG. 4, the content push method may include the following steps.

S301, historical running information of the terminal is acquired.

S302, the historical running information is sent to a server such that the server determines whether the terminal is in a push scenario, wherein the server returns a content to be pushed in the push scenario if the terminal is in the push scenario.

In an embodiment of the present disclosure, the historical running information includes at least one of historical operating information and historical device status information running on the terminal, and the push scenario is a terminal running scenario providing a decision factor in the historical running information determined by a predetermined modeling algorithm and the decision factor reflects a user requirement.

S303, the content to be pushed in the push scenario which is returned by the server is received and output.

In an alternative embodiment, a terminal running information collecting process may be preset in the terminal, and terminal running information thus collected may be sent to the server at a predetermined time interval. Accordingly, the server can automatically obtain the terminal currently-running scenario when pushing the content to be pushed in the push scenario to the terminal; or the terminal may be provided with a process for automatically monitoring the terminal currently-running scenario and the push scenario determined by the server, such that, when monitoring that the terminal currently-running scenario is the push scenario, the process can directly send a push message that the terminal currently-running scenario is the push scenario to the server, then allowing the server to return the push content; or the content push method is performed as the embodiment of the present disclosure shown in FIG. 4.

In an embodiment of the present disclosure, in order to acquire the terminal currently-running scenarios and sent the same to the terminal, a corresponding rule may be acquired from the server in advance, such as the current operation information and the device status information of the terminal; or a rule for a specific preset operation for acquiring the terminal to open, exit or uninstall; as well as a rules for current power consumption, memory size, or a device status of current running application, all of which are not limited to the of the present disclosure.

According to the content push method illustrated in FIG. 4, the terminal currently-running scenario can be sent to the server in real time, and then whether the terminal running scenario is the push scenario is determined by the server according to the historical information. If the terminal running scenario is the push scenario, the content to be pushed in the push scenario is returned by the server, such that the content to be pushed which is returned by the server is received and output. Therefore, in the embodiments of the present disclosure, the content to be pushed in the push scenario received is sent by the server according to the historical running information of the terminal and the terminal currently-running scenario. For example, the content to be pushed in the push scenario received may be the power consumption managing application urgently-required by a user when the power is consumed fast, or a memory size managing application urgently-required by a user when the available memory size is not sufficient, or a download link of an application in the latest version after the application is uninstalled by the user. Therefore, according to embodiments of the present disclosure, the match between the push content and the user's operating requirement can be improved.

FIG. 5 is a flow chart of a further content push method according to an embodiment of the present disclosure. As shown in FIG. 5, the content push method includes following steps.

S401, historical running information of the terminal is acquired.

S402, the historical running information of the terminal is sent to a server such that the server determines whether the terminal is in a push scenario, in which the server returns a content to be pushed in the push scenario if the terminal is in the push scenario.

S403, a push message and output configuration information returned by the server is received and the push message is output in a manner indicated by the output configuration information.

In an embodiment of the present disclosure, the push message is configured to indicate the content to be pushed which is pushed in the terminal running scenario; and the output configuration information includes at least one of an output manner and an output location of the push message, and a jump address of the content to be pushed in the push scenario.

S404, a confirmed push instruction input according to the push message is received.

S405, the confirmed push instruction is responded, and the confirmed push instruction is sent to the server such that the server returns the content to be pushed in the push scenario.

S406, the content to be pushed in the push scenario is received.

In an embodiment of the present disclosure, the received content to be pushed in the push scenario may include an installation package for a push receiving application, a download website for a push receiving application, and a direct opening entry for a power consumption managing application or a memory size managing application.

In an embodiment of the present disclosure, the push scenario may include at least one of a running scenario when an operating instruction for triggering a push content is received by the terminal and a running scenario when the terminal is in a device status for triggering a push content.

In an embodiment of the present disclosure, the detailed description of the terminal running scenario, the output configuration information, the push message, the historical running information, and the content to be pushed can be referred to the relevant description in the above embodiments of the present disclosure, which are not elaborated in detail here again.

According to the content push method illustrated in FIG. 5, the terminal running scenario is acquired; terminal running scenario is sent to the server; whether the terminal running scenario is the push scenario is determined by the server according to the historical running information, if the terminal running scenario is the push scenario, the push message and output configuration information returned by the server are received, such that the push message is output in the manner indicated by the output configuration information. Moreover, when the confirmed push instruction input according to the push message is received, the confirmed push instruction is responded, and the confirmed push instruction is sent to the server such that the server returns the content to be pushed in the push scenario. Therefore, the content to be pushed in the push scenario is returned according to the terminal running scenario, such that the match between the content to be pushed and the user's operation requirements is improved.

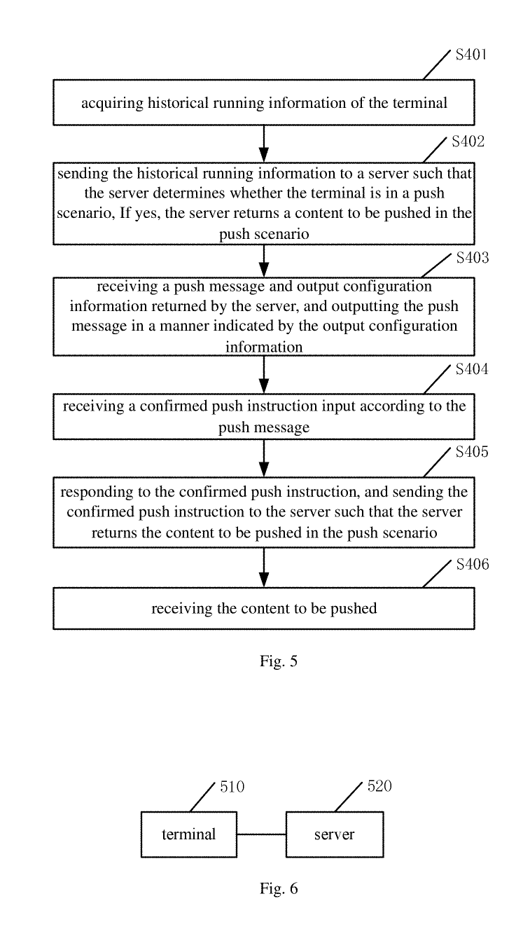

FIG. 6 is a schematic diagram of a content push system according to an embodiment of the present disclosure. The content push system may include at least one terminal and at least one server. Specifically, the at least one terminal may also be called as a client terminal cluster, and the at least one server may also be known as a server cluster, with the client terminal cluster including a mobile phone, a tablet computer, and other wearable device and the server cluster being other integrated managing servers such as a cloud platform maintained by a third-party service provider. Since the operation performed by each terminal in the client terminal cluster is the same for the content push system, the server in the server cluster can perform parallel operations between different terminals according to the terminal identification corresponding to individual terminal. Therefore, as shown in FIG. 6, the content push system is described in detail with the interaction between a terminal 510 and a server 520. Specifically, the content push system includes following steps.

S601, the server 520 acquires historical running information of the terminal 510.

In an embodiment of the present disclosure, the historical running information may include at least one of historical operating information and historical device status information running on the terminal. Specifically, the historical operating information may include an application frequently used by a user in a predetermined time period, an application uninstalled by the user and other information such as an operating habit of the user in the terminal. The historical device status information may include a power consuming speed and an available memory size of a terminal, the number of applications installed in a terminal and other terminal status information.

S602, the server 520 determines a push scenario and a content to be pushed in the push scenario according to the historical running information.

S603, the server 520 detects whether the terminal 510 is in the push scenario. If the terminal 510 is in the push scenario, the content to be pushed in the push scenario and the output configuration information are sent to the terminal 510, otherwise, the procedure is ended.

In an embodiment of the present disclosure, if the historical running information is historical operating information running on the terminal 510, the step of determining a push scenario and a content to be pushed in the push scenario according to the historical running information may be specifically performed as follows.

An operating instruction for triggering a push content and a content to be pushed corresponding to the operating instruction is determined according to the historical operating information.

Accordingly, in 5603, the server 520 detects whether the terminal 510 is in the push scenario. Specifically, the server 520 detects whether the operating instruction is received by the terminal 510, and the server 520 determines that the terminal 510 is in the push scenario if the operating instruction is received by the terminal 510, such that the content to be pushed corresponding to the operating instruction and the output configuration information can be sent to the terminal 510.

For example, if the historical operating information running on the terminal 510 is an application A most frequently used by a user in a predetermined time period, based on such historical operating information, it may be determined by the server 520 that the content to be pushed corresponding to the operating instruction is an application A1 which is the latest version of the application A or an application B which is newly-published and in the same type as that of the application A when the operating instruction is to uninstall the application A. In S603, it may be detected by the server 520 whether such an operating instruction of uninstalling the application A is received by the terminal 510. If this operating instruction of uninstalling the application A is received, a download link or a brief introduction of the application A1 or B may be sent to the terminal 510 by the server 520. Specifically, the push message may be a brief introduction for the content to be pushed corresponding to the operating instruction, such as application identification. The output configuration information includes at least one of an output manner and an output location of the push message, and a jump address of the content to be pushed in the push scenario.

In an embodiment of the present disclosure, if the historical running information is historical device status information running on the terminal 510, the step of determining a push scenario and a content to be pushed in the push scenario according to the historical running information may be specifically performed as follows.

A device status for triggering a push content and a content to be pushed corresponding to the device status are determined according to the historical device status information by the server 520.

Accordingly, in S603, the server 520 determines whether the terminal 510 is in the push scenario. Specifically, the server 520 detects whether the terminal 510 is in the device status, and the server 520 determines that the terminal 510 is in the push scenario if the terminal 510 is in the device status, such that the content to be pushed in the push scenario and the output configuration information can be sent to the terminal 510.

In an embodiment of the present disclosure, the historical device status information may include a power consuming speed and an available memory size of a terminal, and the number of applications running on a terminal. Accordingly, the device status in a push scenario determined according to the historical device status information may include a device status of a power consumption speed reaching a predetermined threshold in a predetermined time period, a device status of a terminal currently-available memory size reaching a predetermined threshold and a device status of the number of applications running on the terminal reaching a predetermined threshold. Accordingly, these device statuses may correspond to a power consumption managing application, a memory size managing application, and an application controlling those applications running on the terminal but not receiving an operating instruction in the predetermined time period to be in a hibernation state.

For example, if the server 520 determines that the power consuming speed of the terminal 510 is fast according to the historical running information of the terminal 510, the device status corresponding thereto may be the power consumption speed of the terminal 510 reaching the predetermined threshold in the predetermined time period. Then, in S603, the server 520 detects whether the terminal 510 is in such a device status, if yes, the push message and the output configuration information thereof corresponding to the content to be pushed according to the device status may be sent to the terminal 510, including at least one of a download link and a brief introduction for the power consumption managing application, and a directly-output prompt of “open the power consumption managing application” in case that the power consumption managing application has already been installed in the terminal. If the content to be pushed according to the device status is the prompt of “open the power consumption application”, the terminal 510 may open the power consumption managing application immediately once receiving a confirmation instruction for the prompt. Specifically, the push message may be a brief introduction for the content to be pushed according to the device status such as application identification. The output configuration information includes at least one of an output manner and an output location of the push message, and a jump address of the content to be pushed in the push scenario.

S604, the terminal 510 outputs the push message in a manner indicated by the output configuration information.

S605, the terminal 510 receives a confirmed push instruction input according to the push message, response to the confirmed push instruction, and sends the confirmed push instruction to the server 520.

S606, the server 520 sends the content to be pushed in the push scenario to the terminal 510.

S607, the terminal 510 receives and outputs the content to be pushed in the push scenario.

In an embodiment of the present disclosure, the received content to be pushed in the push scenario may include an installation package for a push receiving application, a download website for a push receiving application, and a direct opening entry for a power consumption application or a memory size managing application.

In the embodiment of the present disclosure, the server 520 may acquires the historical running information of the terminal, determines the push scenario and a content to be pushed in the push scenario according to the historical running information, and detects whether the terminal 510 is in the push scenario. If the terminal 510 is in the push scenario, the server 520 sends the content to be pushed in the push scenario and the output configuration information to the terminal 510, and terminal 510 can output the push message in the manner indicated by the output configuration information, can response to the confirmed push instruction when receiving the confirmed push instruction input according to the push message, and can send the confirmed push instruction to the server. The server 520 can send the content to be pushed in the push scenario to the terminal, and the terminal 510 can receive and output the content to be pushed in the push scenario. Therefore, according to the embodiment of the present disclosure, the server 520 can send the content to be pushed in the push scenario according to the historical running information of the terminal, thus improving the matching between the push content and the user's operation requirements.

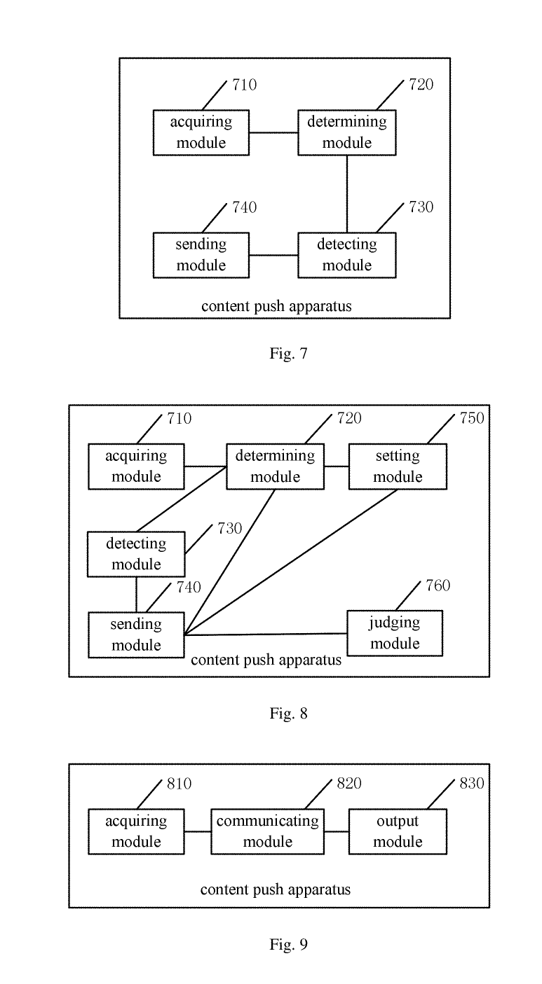

FIG. 7 is a schematic diagram of a content push apparatus according to an embodiment of the present disclosure. As shown in FIG. 7, the content push apparatus may include an acquiring module 710, a determining module 720, a detecting module 730 and a sending module 740.

The acquiring module 710 is configured to acquire historical running information in a terminal.

The determining module 720 is configured to determine a push scenario and a content to be pushed in the push scenario according to the historical running information acquired by the acquiring module.

The push scenario is a terminal running scenario providing a decision factor in the historical running information determined by a predetermined modeling algorithm and the decision factor reflects a user requirement.

The detecting module 730 is configured to detect whether the terminal is in the push scenario.

The sending module 740 is configured to send to the terminal the content to be pushed in the push scenario determined by the determining module 720 if the detecting module detects that the terminal is in the push scenario.

In an embodiment of the present disclosure, the historical running information may include at least one of historical operating information and historical device status information running on the terminal Specifically, the historical operating information may include an application frequently used by a user in a predetermined time period, an application uninstalled by the user and other information such as an operating habit of the user in the terminal. The historical device status information may include a power consumption speed and an available memory size of a terminal, the number of applications installed in a terminal and other terminal status information.

In an embodiment of the present disclosure, if the historical running information is historical operating information running on the terminal, the determining module 720 is further configured to determine an operating instruction for triggering a push content and a content to be pushed corresponding to the operating instruction according to the historical operating information, and the detecting module 730 is further configured to detect whether the operating instruction is received by the terminal, and to determine that the terminal is in the push scenario if the operating instruction is received by the terminal.

For example, if the historical operating information is an application A most frequently used by a user in a predetermined time period, based on such historical operating information, the determining module 720 determines that the content to be pushed corresponding to the operating instruction is an application A1 which is the latest version of the application A or an application B which is newly published and in the same type as that of the application A when the operating instruction is to uninstall the application A. The detecting module 730 detects whether such an operating instruction of uninstalling the application A is received by the terminal If the operating instruction of uninstalling the application A is received, a download link or a brief introduction of the application A1 or B may be sent to the terminal.

In an embodiment of the present disclosure, if the historical running information is historical device status information running on the terminal, the determining module 720 is further configured to determine a device status for triggering a push content and a content to be pushed corresponding to the device status according to the historical device status information, and the detecting module 730 is further configured to detect whether the terminal is in the device status, and to determine that the terminal is in the push scenario if the terminal is in the device status.

For example, if the determining module 720 determines that the power consumption speed of the terminal is fast according to the historical running information of the terminal, the device status corresponding thereto may be the power consumption speed of the terminal reaching a predetermined threshold in the predetermined time period, then the detecting module 730 detects that the terminal is in such a device status, if yes, the content to be pushed according to the device status may be sent to the terminal, including at least one of a download link and a brief introduction for the power consumption managing application, and a directly-output prompt of “open the power consumption managing application”, in case that the power consumption managing application has already been installed in the terminal. If the content to be pushed according to the device status is the prompt of “open the power consumption managing application”, the terminal may open the power consumption managing application immediately once receiving a confirmation instruction for the prompt.

FIG. 8 is a schematic diagram of another content push apparatus according to an embodiment of the present disclosure. Specifically, the content push apparatus shown in FIG. 8 is an alternative apparatus after further optimization for the content push apparatus shown in FIG. 7. Besides the acquiring module 710, the determining module 720, the detecting module 730 and the sending module 740 shown in FIG. 7, the content push apparatus of FIG. 8 further includes a setting module 750 and a judging module 760.

The setting module 750 is configured to set output configuration information of a push message.

In an embodiment of the present disclosure, the push message is configured to indicate the content to be pushed which is pushed in the terminal running scenario, and the output configuration information includes at least one of an output manner and an output location of the push message, and a jump address of the content to be pushed in the push scenario.

If the terminal is in the push scenario, the sending module 740 is further configured to send the push message and the output configuration information to the terminal, such that the terminal outputs the push message in a manner indicated by the output configuration information.

The judging module 760 is configured to judge whether a confirmed push instruction input according to the push message is received, and to trigger the sending module 740 to execute an operation of sending to the terminal the content to be pushed in the push scenario if the confirmed push instruction input according to the push message is received.

In an embodiment of the present disclosure, the push message is configured to indicate the content to be pushed which is pushed in the terminal running scenario and may include a download link and a brief introduction for an application to be pushed, and an entry prompting other operations (e.g., updating an application), etc.. The output configuration information includes at least one of an output manner and an output location of the push message, and a jump address of the content to be pushed in the push scenario. For example, the output configuration information may be predefined in the setting module 750, or set by a user via a configuration interface of the setting module 750 as shown in FIG. 3. FIG. 3 is a schematic diagram showing output configuration information according to an embodiment of the present disclosure. A content to be set of the output configuration information may include a notification bar title, a notification bar content, a jump address, a text on button, an application identification, and a push notification bar identification. Taking the push message is configure to indicate that the content to be pushed corresponding to the operating instruction is the power consumption managing application A1 as an example, in the output configuration information, the notification bar title may be set as the power consumption managing application, the notification bar content may be set as a brief introduction for the power consumption managing application A1 (such as a memory size occupied for installation, a developer and version information), the jump address may set as a download link for the power consumption managing application A1, the text on button may be set to confirm or to ignore the push message, an application identification may be set as an icon of the power consumption managing application A1 and the push notification bar identification may be set as an icon of the push content corresponding to the device status.

In an embodiment of the present disclosure, if the detecting module 730 detects that the terminal is in the push scenario, the push message and the output configuration information are sent to the terminal, such that the terminal outputs the push message in the manner indicated by the output configuration information Alternatively, the output configuration information may also be in a voice prompt manner, for example, except for the jump address which may be output in a prompt bar manner, other information described above, such as the notification bar title, the notification bar content, the text on button, the application identification and the push notification bar identification, may be output in the voice prompt manner. Alternatively, the output configuration information may be set as broadcasting the push message including the brief introduction for the content to be pushed in the voice prompt manner only.

In an embodiment of the present disclosure, the confirmed push instruction may be a click instruction or a sliding operation by the user for confirming the text on button input in the prompt bar for the push message output as the output configuration information, or an voice confirmation instruction input by the user in response to the push message, as well as other preset operating instructions for confirming the allowed content to be pushed, which is not limited to embodiments of the present disclosure.

According to the content push apparatus illustrated in FIG. 7 or FIG. 8, the acquiring module 710 acquires historical running information of the terminal, the determining module 720 determines a push scenario and a content to be pushed in the push scenario according to the historical running information, in which the push scenario refers to a terminal running scenario configured to trigger the push content, the detecting module 730 is configured to detect whether the terminal is in the push scenario, and the sending module 740 is configured to send to the terminal the content to be pushed in the push scenario determined by the determining module if the detecting module detects that the terminal is in the push scenario, such that the terminal outputs the content to be pushed in the push scenario. Therefore, according to embodiments of the present disclosure, it is possible to push different contents according to different running scenarios of the terminal, thus improving the match between the push content and the user's operation requirements.

Moreover, in the content push apparatus shown in FIG. 8, the setting module is configured to set output configuration information of a push message. When the detecting module detects that the terminal is in the push scenario, the sending module at first sends the push message and the output configuration information to the terminal, such that the terminal outputs the push message in a manner indicated by the output configuration information; and when the judging module judges that the confirmed push instruction input according to the push message is received, the sending module then sends to the terminal the content to be pushed in the push scenario. Because the push message is configured to indicate the content to be pushed in the terminal running scenario, which may be a brief introduction or other related information of the content to be pushed in the terminal running scenario, with a data volume lower than that of the push content. Accordingly, it is not required to push the content to be pushed if the confirmed push instruction input according to the push message is not received, thus saving network resource and avoiding the terminal from being disturbed at the same time. Therefore, the match between the content to be pushed and the user's operation requirements and the user's operating experience are both improved.

FIG. 9 is a schematic diagram of a further content push apparatus according to an embodiment of the present disclosure. As shown in FIG. 9, the content push apparatus may include an acquiring module 810, a communicating module 820 and an output module 830.

The acquiring module 810 is configured to acquire historical running information of the terminal.

The communicating module 820 is configured to send the historical running information of the terminal to a server such that it is determined by the server whether the terminal is in a push scenario, in which the server returns a content to be pushed in the push scenario if the terminal is in the push scenario, the historical running information includes at least one of historical operating information and historical device status information running on the terminal, the push scenario is a terminal running scenario providing a decision factor in the historical running information determined by a predetermined modeling algorithm and the decision factor reflects a user requirement.

The communicating module 820 is further configured to receive the content to be pushed in the push scenario which is returned by the server.

The output module 830 is configured to output the content to be pushed in the push scenario which is received by the communicating module.

In an embodiment of the present disclosure, the communicating module 820 is further configured to receive a push message and output configuration information returned by the server, in which the push message is configured to indicate the content to be pushed which is pushed in the terminal running scenario, and the output configuration information includes at least one of an output manner and an output location of the push message, and a jump address of the content to be pushed in the push scenario.

The output module 830 is further configured to output the push message in a manner indicated by the output configuration information.

In an embodiment of the present disclosure, after the push message is output by the output module in a manner indicated by the output configuration information and before the content to be pushed returned by the server is received and output by the output module, the communicating module 820 is further configured to receive a confirmed push instruction input according to the push message, and respond to the confirmed push instruction, and send the confirmed push instruction to the server such that the server returns the content to be pushed in the push scenario.

In an embodiment of the present disclosure, the push scenario includes at least one of a running scenario when an operating instruction for triggering a push content is received by the terminal and a running scenario when the terminal is in a device status for triggering a push content.

In an embodiment of the present disclosure, a terminal running information collecting process may be preset in the terminal by the content push apparatus and terminal running information thus collected may be sent to the server at a predetermined time interval.

In the content push apparatus shown in FIG. 9, the acquiring module acquires the historical running information of the terminal, which is sent to the server by the communicating module, such that the server determines whether the terminal running scenario is in a push scenario according to the historical running information of the terminal. If the terminal running scenario is in the push scenario, the server returns a content to be pushed in the push scenario, and the output module outputs the content to be pushed in the push scenario which is returned by the server. Therefore, in the embodiments of the present disclosure, the content to be pushed in the push scenario received is sent by the server according to the historical running information of the terminal and the terminal currently-terminal running scenario. For example, the content to be pushed in the push scenario received may be the power consumption managing application urgently-required by a user when the power is consumed fast, or a memory size managing application urgently-required by a user when the available memory size is not sufficient, or a download link of an application in the latest version after the application is uninstalled by the user. Therefore, according to embodiments of the present disclosure, the match between the push content and the user's operating requirement can be improved. Moreover, the communication module further receives the push message in the push scenario returned by the server and output configuration information is received by the communicating module, such that the push message is output by the output module in a manner indicated by the output configuration information. Further, after receiving a confirmed push instruction input according to the push message, the communicating module responses to the confirmed push instruction, sends the confirmed push instruction to the server, such that the server returns the content to be pushed in the push scenario, thus improving the match between t the content to be pushed and the user's operation requirements.

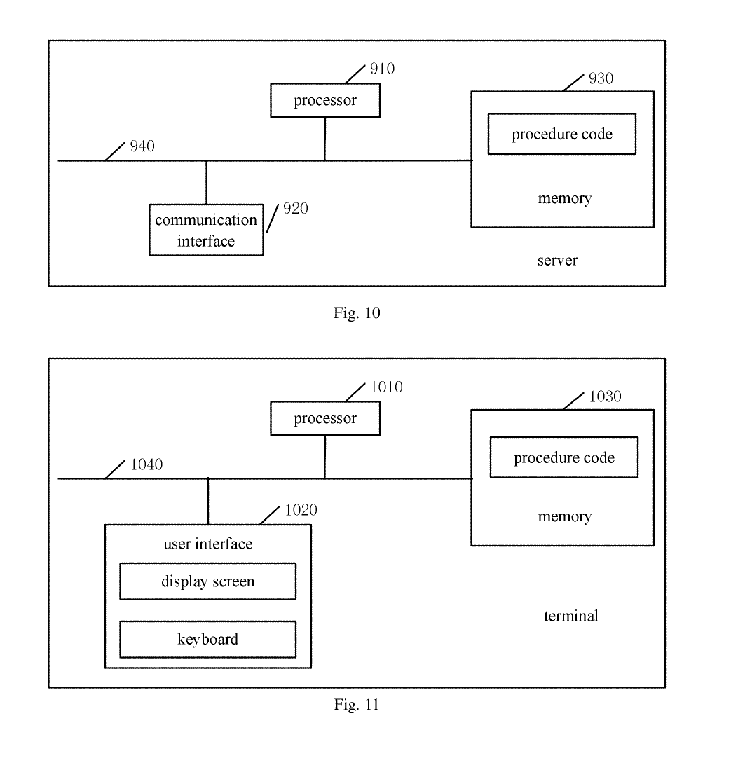

FIG. 10 is a schematic diagram of a server according to an embodiment of the present disclosure. As shown in FIG. 10, the server may include a processor 910, a communication interface 920 and a memory 930. Specifically, a communication bus 940 is configured to realise communications among the components. The memory 930 may be a high-speed random-access memory (RAM), or a non-volatile memory, such as at least one disk memory. Alternatively, the memory 930 may be at least one memory located away from the processor 910. Specifically, for the processor 910 may refer to the content push apparatuses shown in FIG. 7 or FIG. 8. A set of procedure codes is stored in the memory 930, and the set of procedure codes in the memory 930 is called by the processor 910 to perform following steps:

acquiring historical running information of a terminal;

determining a push scenario and a content to be pushed in the push scenario according to the historical running information, wherein the push scenario is a terminal running scenario providing a decision factor in the historical running information determined by a predetermined modeling algorithm and the decision factor reflects a user requirement;

detecting whether the terminal is in the push scenario; and

sending to the terminal the content to be pushed in the push scenario if the terminal is in the push scenario.

The historical running information includes at least one of historical operating information and historical device status information running on the terminal Specifically, the historical operating information may include an application frequently used by a user in a predetermined time period, an application uninstalled by the user and other information such as an operating habit of the user in the terminal. The historical device status information may include a power consumption speed and an available memory size of a terminal, the number of applications installed in a terminal and other terminal status information.

In embodiments of the present disclosure, the content to be pushed in the push scenario may include installation package download links for various applications and their respective brief introductions, an entry prompting other operations and a predetermined content related to the historical running information for the individual application, etc., which is not limited to the embodiments of the present disclosure.

In an embodiment of the present disclosure, the processor 910 is configured to call the procedure code in the memory 930. If the historical running information is historical operating information running on the terminal, the step of determining a push scenario and a content to be pushed in the push scenario according to the historical running information may be specifically performed as follows.

An operating instruction for triggering a push content and a content to be pushed corresponding to the operating instruction is determined according to the historical operating information.

Accordingly, the procedure code in the memory 930 is called by the processor 910, a step of detecting whether the terminal is in the push scenario includes: detecting whether the operating instruction is received by the terminal, and determining that the terminal is in the push scenario if the operating instruction is received by the terminal.

In an embodiment of the present disclosure, the procedure code in the memory 930 is called by the processor 910. If the historical running information is historical device status information running on the terminal, the step of determining a push scenario and a content to be pushed in the push scenario according to the historical running information may be specifically performed as follows.

A device status for triggering a push content and a content to be pushed corresponding to the device status are determined according to the historical device status information.

Accordingly, the procedure code in the memory 930 is called by the processor 910, a step of detecting whether the terminal is in the push scenario includes: detecting whether the terminal is in the device status, and determining that the terminal is in the push scenario if the terminal is in the device status.

In an embodiment of the present disclosure, the procedure code in the memory 930 is called by the processor 910, after determining a push scenario and a content to be pushed in the push scenario according to the historical running information, following steps may be performed.

Output configuration information of a push message is set, in which the push message is configured to indicate the content to be pushed which is pushed in the terminal running scenario; and the output configuration information includes at least one of an output manner and an output location of the push message, and a jump address of the content to be pushed in the push scenario.

If the terminal is in the push scenario, the procedure code in the memory 930 is called by the processor 910, following steps may be performed.

The push message and the output configuration information are sent to the terminal such that the terminal outputs the push message in a manner indicated by the output configuration information.

In an embodiment of the present disclosure, the procedure code in the memory 930 is called by the processor 910, after sending the push message and the output configuration information to the terminal such that the terminal outputs the push message in a manner indicated by the output configuration information, following steps may be performed.

It is judged whether a confirmed push instruction input according to the push message is received.

A step of sending to the terminal the content to be pushed in the push scenario is executed if the confirmed push instruction input according to the push message is received.

A part or all of the procedures for the content push method according to embodiments introduced with reference to FIGS. 1 to 3 may be realised by the server described in embodiments of the present disclosure.

In an embodiment of the present disclosure, the historical running information of a terminal is acquired by the processor, and it is determined that a push scenario and a content to be pushed in the push scenario according to the historical running information, in which the push scenario is a terminal running scenario providing a decision factor in the historical running information determined by a predetermined modeling algorithm and the decision factor reflects a user requirement, when it is detected by the processor that the terminal is in the push scenario, the content to be pushed in the push scenario is sent to the terminal, such that the terminal outputs the content to be pushed. Therefore, according to embodiments of the present disclosure, it is possible to push different contents according to different running scenarios of the terminal, thus improving the match between the push content and the user's operation requirements.

FIG. 11 is a schematic diagram of a terminal according to an embodiment of the present disclosure. As shown in FIG. 11, the terminal may include at least one processor 1010 such as a central processing unit (CPU), a user interface 1020 including a keyboard, a mouse and a display screen, a memory 1030, and at least one communication bus 1040. Specifically, the communication bus 1040 is configured to realise communications among the components. The memory 1030 may be a high-speed random-access memory (RAM), or a non-volatile memory, such as at least one disk memory. Alternatively, the memory 930 may be at least one memory located away from the processor 1010. Specifically, the processor 1010 may refer to the content push apparatus as shown in FIG. 9. A set of procedure codes is stored in the memory 1030, and the set of procedure codes in the memory 1030 is called by the processor 1010 to perform following steps:

acquiring historical running information of the terminal;

sending the historical running information to a server such that the server determines whether the terminal is in a push scenario, wherein the server returns a content to be pushed in the push scenario if the terminal is in the push scenario, the historical running information includes at least one of historical operating information and historical device status information running on the terminal, and the push scenario is a terminal running scenario providing a decision factor in the historical running information determined by a predetermined modeling algorithm and the decision factor reflects a user requirement; and

receiving and outputting the content to be pushed in the push scenario which is returned by the server.

In an embodiment of the present disclosure, the procedure code in the memory 1030 is called by the processor 1010, and following steps may further be performed:

receiving a push message and output configuration information returned by the server, wherein the push message is configured to indicate the content to be pushed which is pushed in the terminal running scenario; and the output configuration information includes at least one of an output manner and an output location of the push message, and a jump address of the content to be pushed in the push scenario; and

outputting the push message in a manner indicated by the output configuration information.

In an embodiment of the present disclosure, the procedure code in the memory 1030 is called by the processor 1010, and after outputting the push message in a manner indicated by the output configuration information and before receiving and outputting the content to be pushed which is returned by the server, following steps may further be performed:

receiving a confirmed push instruction input according to the push message;

responding to the confirmed push instruction, and sending the confirmed push instruction to the server such that the server returns the content to be pushed in the push scenario.

In an embodiment of the present disclosure, the push scenario includes at least one of a running scenario when an operating instruction for triggering a push content is received by the terminal and a running scenario when the terminal is in a device status for triggering a push content.

A part or all of the procedures for the content push method according to embodiments introduced with reference to FIG. 4 and FIG. 5 may be realised in embodiments of the present disclosure.

In an embodiment of the present disclosure, the terminal currently-running scenario can be sent to the server in real time by the processor, and then whether the terminal running scenario is the push scenario is determined by the server according to the historical information. If the terminal running scenario is the push scenario, the content to be pushed in the push scenario is returned by the server, such that the content to be pushed which is returned by the server is received and output. Therefore, in the embodiments of the present disclosure, the content to be pushed in the push scenario received is sent by the server according to the historical running information of the terminal and the terminal currently-running scenario. For example, the content to be pushed in the push scenario received may be the power consumption managing application urgently-required by a user when the power is consumed fast, or a memory size managing application urgently-required by a user when the available memory size is not sufficient, or a download link of an application in the latest version after the application is uninstalled by the user. Therefore, according to embodiments of the present disclosure, the match between the push content and the user's operating requirement can be improved.

In addition, the present disclosure provides in embodiments a computer readable storage medium having stored therein a computer program that, when executed, is configured to perform a content push method according to an embodiment of the present disclosure. Specifically, the content push method provided in an embodiment of the present disclosure may include:

acquiring historical running information of a terminal;

determining a push scenario and a content to be pushed in the push scenario according to the historical running information, wherein the push scenario is a terminal running scenario providing a decision factor in the historical running information determined by a predetermined modeling algorithm and the decision factor reflects a user requirement;

detecting whether the terminal is in the push scenario; and

sending to the terminal the content to be pushed in the push scenario if the terminal is in the push scenario.

In addition, the present disclosure provides in embodiments a computer program, which when running, performs a content push method described in embodiments of the present disclosure. Specifically, the content push method according to an embodiment of the present disclosure may include:

acquiring historical running information of a terminal;

determining a push scenario and a content to be pushed in the push scenario according to the historical running information, wherein the push scenario is a terminal running scenario providing a decision factor in the historical running information determined by a predetermined modeling algorithm and the decision factor reflects a user requirement;

detecting whether the terminal is in the push scenario; and

sending to the terminal the content to be pushed in the push scenario if the terminal is in the push scenario.

In addition, the present disclosure provides in embodiments a storage medium having stored therein a computer program that, when executed, is configured to perform a content push method according to an embodiment of the present disclosure. Specifically, the content push method provided in an embodiment of the present disclosure may include:

acquiring historical running information of the terminal;

sending the historical running information to a server such that the server determines whether the terminal is in a push scenario, wherein the server returns a content to be pushed in the push scenario if the terminal is in the push scenario, the historical running information includes at least one of historical operating information and historical device status information running on the terminal, and the push scenario is a terminal running scenario providing a decision factor in the historical running information determined by a predetermined modeling algorithm and the decision factor reflects a user requirement; and

receiving and outputting the content to be pushed in the push scenario which is returned by the server.

In addition, the present disclosure provides in embodiments a computer program, which when running, performs a content push method described in embodiments of the present disclosure. Specifically, the content push method according to an embodiment of the present disclosure may include:

acquiring historical running information of the terminal;

sending the historical running information to a server such that the server determines whether the terminal is in a push scenario, wherein the server returns a content to be pushed in the push scenario if the terminal is in the push scenario, the historical running information includes at least one of historical operating information and historical device status information running on the terminal, and the push scenario is a terminal running scenario providing a decision factor in the historical running information determined by a predetermined modeling algorithm and the decision factor reflects a user requirement; and

receiving and outputting the content to be pushed in the push scenario which is returned by the server.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples.

In the description of the present disclosure, terms such as “first” and “second” are used herein for purposes of description and are not intended to indicate or imply relative importance or significance. Furthermore, in the description of the present disclosure, “a plurality of” refers to two or more unless otherwise specified.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A content push method applied in a server, comprising:
acquiring historical running information of a terminal;
determining a push scenario and a content to be pushed in the push scenario according to the historical running information, wherein the push scenario is a terminal running scenario providing a decision factor in the historical running information determined by a predetermined modeling algorithm and the decision factor reflects a user requirement;
detecting whether the terminal is in the push scenario; and
sending to the terminal the content to be pushed in the push scenario if the terminal is in the push scenario.

2. The method according to claim 1, wherein the historical running information is historical operating information running on the terminal;
determining a push scenario and a content to be pushed in the push scenario according to the historical running information comprises:
determining an operating instruction for triggering a push content and a content to be pushed corresponding to the operating instruction according to the historical operating information; and
detecting whether the terminal is in the push scenario comprises:
detecting whether the operating instruction is received by the terminal, and
determining that the terminal is in the push scenario if the operating instruction is received by the terminal.

3. The method according to claim 1, wherein the historical running information is historical device status information running on the terminal;
determining a push scenario and a content to be pushed in the push scenario according to the historical running information comprises:
determining a device status for triggering a push content and a content to be pushed corresponding to the device status according to the historical device status information; and
detecting whether the terminal is in the push scenario comprises:
detecting whether the terminal is in the device status, and
determining that the terminal is in the push scenario if the terminal is in the device status.

4. The method according to claim 1, wherein after determining a push scenario and a content to be pushed in the push scenario according to the historical running information, the method further comprises:
setting output configuration information of a push message, wherein the push message is configured to indicate the content to be pushed which is pushed in the terminal running scenario; and the output configuration information comprises at least one of an output manner and an output location of the push message, and a jump address of the content to be pushed in the push scenario;
if the terminal is in the push scenario, the method further comprises:
sending the push message and the output configuration information to the terminal such that the terminal outputs the push message in a manner indicated by the output configuration information.

5. The method according to claim 4, wherein after sending the push message and the output configuration information to the terminal such that the terminal outputs the push message in a manner indicated by the output configuration information, the method further comprises:
judging whether a confirmed push instruction input according to the push message is received; and
executing a step of sending to the terminal the content to be pushed in the push scenario if the confirmed push instruction input according to the push message is received.

6. A content push method applied in a terminal, comprising:
acquiring historical running information of the terminal;
sending the historical running information to a server such that the server determines whether the terminal is in a push scenario, wherein the server returns a content to be pushed in the push scenario if the terminal is in the push scenario, the historical running information comprises at least one of historical operating information and historical device status information running on the terminal, and the push scenario is a terminal running scenario providing a decision factor in the historical running information determined by a predetermined modeling algorithm and the decision factor reflects a user requirement; and
receiving and outputting the content to be pushed in the push scenario which is returned by the server.

7. The method according to claim 6, further comprising:
receiving a push message and output configuration information returned by the server, wherein the push message is configured to indicate the content to be pushed which is pushed in the terminal running scenario; and the output configuration information comprises at least one of an output manner and an output location of the push message, and a jump address of the content to be pushed in the push scenario; and
outputting the push message in a manner indicated by the output configuration information.

8. The method according to claim 7, wherein after outputting the push message in a manner indicated by the output configuration information and before receiving and outputting the content to be pushed which is returned by the server, the method further comprises:
receiving a confirmed push instruction input according to the push message;
responding to the confirmed push instruction, and sending the confirmed push instruction to the server such that the server returns the content to be pushed in the push scenario.

9. The method according to claim 6, wherein the push scenario comprises at least one of a running scenario when an operating instruction for triggering a push content is received by the terminal and a running scenario when the terminal is in a device status for triggering a push content.

10. A server, comprising a content push apparatus comprising:
one or more processors;
a memory;
one or more software modules stored in the memory and executable by the one or more processors, and comprising:
an acquiring module configured to acquire historical running information in a terminal;
a determining module configured to determine a push scenario and a content to be pushed in the push scenario according to the historical running information acquired by the acquiring module, wherein the push scenario is a terminal running scenario providing a decision factor in the historical running information determined by a predetermined modeling algorithm and the decision factor reflects a user requirement;
a detecting module configured to detect whether the terminal is in the push scenario; and
a sending module configured to send to the terminal the content to be pushed in the push scenario determined by the determining module if the detecting module detects that the terminal is in the push scenario.

11. The server according to claim 10, wherein the historical running information is historical operating information running on the terminal;
the determining module is configured to determine an operating instruction for triggering a push content and a content to be pushed corresponding to the operating instruction according to the historical operating information; and
the detecting module is configured to detect whether the operating instruction is received by the terminal, and to determine that the terminal is in the push scenario if the operating instruction is received by the terminal.

12. The server according to claim 10, wherein the historical running information is historical device status information running on the terminal;
the determining module is configured to determine a device status for triggering a push content and a content to be pushed corresponding to the device status according to the historical device status information; and
the detecting module is configured to detect whether the terminal is in the device status, and to determine that the terminal is in the push scenario if the terminal is in the device status.

13. The server according to claim 10, further comprising:
a setting module configured to set output configuration information of a push message, wherein the push message is configured to indicate the content to be pushed which is pushed in the terminal running scenario; and the output configuration information comprises at least one of an output manner and an output location of the push message, and a jump address of the content to be pushed in the push scenario; and
if the terminal is in the push scenario, the sending module is further configured to send the push message and the output configuration information to the terminal, such that the terminal outputs the push message in a manner indicated by the output configuration information.

14. The server according to claim 13, further comprising:
a judging module configured to judge whether a confirmed push instruction input according to the push message is received, and to trigger the sending module to execute an operation of sending to the terminal the content to be pushed in the push scenario if the confirmed push instruction input according to the push message is received.

15. A terminal, comprising a content push apparatus comprising:
one or more processors;
a memory;
one or more software modules stored in the memory and executable by the one or more processors, and comprising:
an acquiring module configured to acquire historical running information of the terminal;
a communicating module configured to send the historical running information of the terminal to a server such that the server determines whether the terminal is in a push scenario, wherein the server returns a content to be pushed in the push scenario if the terminal is in the push scenario, the historical running information comprises at least one of historical operating information and historical device status information running on the terminal, the push scenario is a terminal running scenario providing a decision factor in the historical running information determined by a predetermined modeling algorithm and the decision factor reflects a user requirement, and the communicating module is further configured to receive the content to be pushed in the push scenario which is returned by the server; and
an output module configured to output the content to be pushed which is received in the push scenario by the communicating module.

16. The terminal according to claim 15, wherein the communicating module is further configured to receive a push message and output configuration information returned by the server, wherein the push message is configured to indicate the content to be pushed which is pushed in the terminal running scenario; and the output configuration information comprises at least one of an output manner and an output location of the push message, and a jump address of the content to be pushed in the push scenario; and
the output module is further configured to output the push message in a manner indicated by the output configuration information.

17. The terminal according to claim 16, wherein after the push message is output by the output module in a manner indicated by the output configuration information and before the content to be pushed returned by the server is received and output by the output module, the communicating module is further configured to:
receive a confirmed push instruction input according to the push message;
respond to the confirmed push instruction, and send the confirmed push instruction to the server such that the server returns the content to be pushed in the push scenario.

18. The terminal according to claim 15, wherein the push scenario comprises at least one of a running scenario when an operating instruction for triggering a push content is received by the terminal and a running scenario when the terminal is in a device status for triggering a push content.
